(19) United States
(12) Patent Application Publication
(10) Pub. No.: US 2005/0042335 A1
(43) Pub. Date: Feb. 24, 2005

(54) Packaged livestock ingestible

(76) Inventor: Robert H. Stock, Manlius, NY (US)

Correspondence Address: S. Wade Johnson;DORSEY & WHITNEY LLP, Intellectual Property Department, 50 South Sixth Street, Suite 1500, Minneapolis, MN, 55402-1498, US

(21) Appl. No.: 10/646,477

(22) Filed: Aug. 22, 2003

(51) Int. Cl. C12C 1/027

(52) U.S. Cl. 426/106

(57) ABSTRACT

The present invention is an edible nutritional food in the form of an integral, self-sustaining body within a dosage package. The invention comprises a sugar-based sweetening ingredient, a quantity of oil and/or fat, a quantity of a supplement mixed with said sweetening ingredient and oil and/or fat, and a dosage package. The supplement comprises an ingredient selected from the group consisting of proteins, vitamins, minerals, phytochemicals, nutraceuticals and other nutrients. This ingredient is supplied in a measured proportion. The dosage package contains a metered amount of the supplement mixed with said sweetening ingredient and oil and/or fat. The amount of supplement is sufficient to provide a predetermined measured dose of said supplement. The dosage package comprises a container with moisture barrier qualities. The dosage package is filled with the metered amount, which conforms to the shape of the container. The container is sealed with a removable moisture barrier. The metered amount has a total moisture content of less than about 8% by weight, based upon the total weight of the metered amount taken as 100% by weight.

### BACKGROUND OF THE INVENTION

The present invention relates to animal feed supplements. More specifically, the present invention relates to packaged animal feed supplements.

Livestock exhibitors and trainers often work closely with an individual animal in preparation for a livestock competition. Examples of such livestock competitions include equestrian events such as jumping, racing, cutting, pleasure riding, endurance riding, roping, polo, showing, etc. Other examples of livestock competitions include showing cattle, horses, sheep, swine, goats, lamas, etc., at livestock exhibits such as at state fairs.

To successfully compete in a livestock competition, the trainer must work closely with the animal to maintain the animal in top physical condition and to develop the necessary rapport with the animal. To maintain top physical condition, the animal must receive daily the proper types and doses of nutrients. This can be challenging because of metabolic and genetic differences between individual animals of the same breed, because of nutritional differences that exist within the same types of feed, and because of different levels of stress or exertion the animal may undergo at different time periods. For example, one quarter horse may be deficient in one type of nutrient, while another quarter horse may be deficient in another type of nutrient, although both horses receive the same feed. Also, for example, alfalfa hay from one area of a state may have nutritional deficiencies not found in alfalfa hay from another area of the same state. Finally, as compared to precompetition periods, a cutting horse may require more protein and minerals during and immediately after a competition to replace those consumed during the competition.

Livestock owners have enhanced the diets of their livestock by providing, in a pasture or stockyard, low-moisture, molasses-based, feed supplements in the form of solid blocks. However, for the following reasons, these supplement blocks are less than desirable for use with competition livestock. First, the blocks are typically heavy and do not lend themselves to being moved from competition to competition as the trainer and animal travel the competition circuit. Second, the weight of the blocks makes it inconvenient to travel with a variety of nutritionally different blocks that can be substituted to adapt the animal's diet to the circumstances being experienced by the animal. Furthermore, in the context of pleasure and endurance riding, the size and weight of the blocks prevent them from being carried in a saddlebag. As a result, the blocks cannot be utilized on the trail to provide energy and to replace lost nutrients. Third, the animals consume the blocks ad libitum, which makes it difficult, if not impossible, to finely tune the animal's diet as required for successful competition, and, for the same reason, medicaments contained in the blocks cannot be delivered in prescribed doses. Fourth, since the animal consumes the block ad libitum, the animal is less likely to see the block as a treat provided by the trainer, and the trainer and animal miss a rapport-building opportunity. Finally, low-moisture, molasses-based, feed supplement blocks are hydroscopic and will become sticky and messy when exposed to moisture.

Medicating a competition animal can be stressful to the rapport developed between the animal and its trainer, because medicating often requires the animal be restrained against its will (e.g., restrained by a squeeze shoot) as it endures some discomfort (e.g., having boluses forced down the animal's throat or receiving an injection). Often, medications require multiple dosages that need to be repeated daily over a period of time. Because medications often have smells and/or tastes that animals find unpleasant, it is difficult to get an animal to ingest the medication regularly without subjecting the animal to restraint and discomfort.

There is a need for ingestibles (i.e., a product to be ingested by a livestock animal) that allow a livestock trainer or exhibitor to provide supplements and medications in measured doses to livestock in a manner that builds rapport between the livestock and the trainer or exhibitor. Further, there is a need for an ingestible that is convenient to transport and is relatively mess free.

### BRIEF SUMMARY OF THE INVENTION

The present invention, in one embodiment, is a method of forming a nutritional food product. The method comprises the steps of: forming a mixture comprising a sugar-based sweetening ingredient and a quantity of oil and/or fat; cooking said mixture by heating to a temperature of from about 220-320 degrees F. to yield a low-moisture cooked liquid mixture; mixing said liquid mixture with a measured proportional quantity of dry materials including an ingredient selected from the group consisting of vitamins, minerals, proteins, phytochemicals, nutraceuticals and other nutrients and mixtures thereof, said ingredient to be delivered in a measured dose; supplying said mixture, which now contains the dry materials, to a metering device; delivering in a highly viscous state out of the metering device and into a container with moisture barrier qualities a measured amount of the mixture sufficient to provide a predetermined measured dose of said ingredient, said container serving as a mold for shaping the measured amount into a solid, integral mass upon cooling; and sealing the container with a removable moisture barrier.

The present invention, in another embodiment, is an edible food in the form of an integral, self-sustaining body within a dosage package. The invention comprises a sugar-based sweetening ingredient, a quantity of oil and/or fat, a quantity of a supplement mixed with said sweetening ingredient and oil and/or fat, and a dosage package. The supplement comprises an ingredient selected from the group consisting of proteins, vitamins, minerals, phytochemicals, nutraceuticals and other nutrients. This ingredient is supplied in a measured proportion. The dosage package contains a metered amount of the supplement mixed with said sweetening ingredient and oil and/or fat. The amount of supplement is sufficient to provide a predetermined measured dose of said supplement. The dosage package comprises a container with moisture barrier qualities. The dosage package is filled with the metered amount, which conforms to the shape of the container. The container is sealed with a removable moisture barrier. The metered amount has a total moisture content of less than about 8% by weight, based upon the total weight of the metered amount taken as 100% by weight.

The present invention, in another embodiment, is a method of administering a livestock supplement. The method comprises: selecting a livestock animal to receive a livestock supplement; determining at least one characteristic of the livestock animal selected from the group consisting of species, breed, gender, age, weight, physical condition, health condition, type of nutritional deficiency, type of illness, activity level, and dietary intake; selecting a packaged livestock supplement that provides a single controlled dose of ingredients formulated to correspond to the at least one characteristic, wherein the packaged livestock supplement comprises a low-moisture, molasses-based product sealed in a container having a removable lid, the container and lid having moisture barrier qualities; removing the molasses-based product from the container; and providing the molasses-based product to the livestock animal.

The present invention, in another embodiment, is a set of packaged supplements for regimented administration to a livestock animal. The set comprises a plurality of packaged base supplements, at least one packaged special supplement, a container, and an indicator. The container is adapted to hold said plurality of base supplements and said at least one special supplement. The indicator indicates the order in which the base and special supplements are to be administered to the livestock animal during a predetermined administration period. The base supplement is formulated to maintain the livestock animal's overall health, and the special supplement is formulated to meet the animal's special health needs. The base and special supplements are arranged in the container to indicate the order in which the supplements are to be administered to the livestock animal during the predetermined administration period. The total number of supplements held within the container corresponds to the number of supplements to be administered during the predetermined administration period.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side elevation view of a packaged livestock supplement.

FIG. 1A is a sectional view taken through a sidewall as indicated in FIG. 1.

FIG. 2 is an end elevation view of the packaged livestock supplement illustrated in FIG. 1.

FIG. 3 is a top view of the packaged livestock supplement illustrated in FIG. 1.

FIG. 4 is a side elevation view of an alternative embodiment of the tray used for the packaged livestock supplement.

FIG. 5 is a top view of the tray illustrated in FIG. 4.

FIG. 6 is a side elevation view of an alternative embodiment of the tray used for the packaged livestock supplement.

FIG. 7 is a top view of the tray illustrated in FIG. 6.

FIG. 8 is a set of packaged livestock supplements held in a container adapted for the purpose and used in a regimented system for administering packaged livestock supplements.

FIG. 9 is a set of packaged livestock supplements held in a container adapted for the purpose and used in a regimented system for administering packaged livestock supplements.

### DESCRIPTION OF THE INVENTION

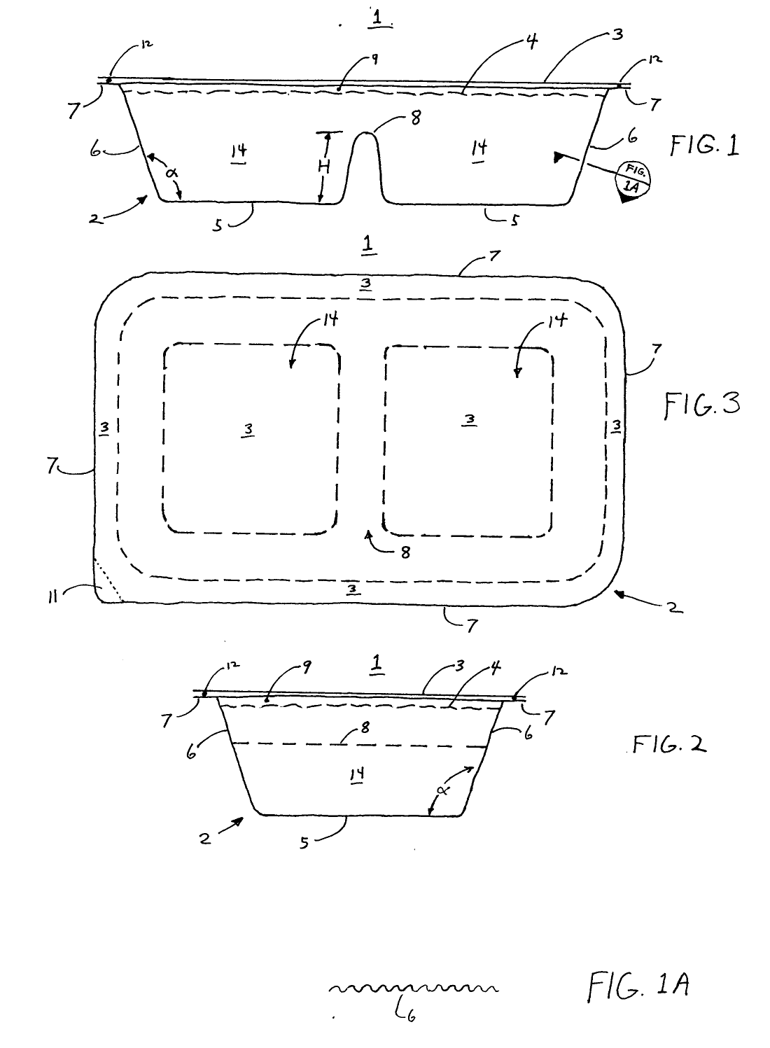

FIG. 1 is a side elevation view of a packaged livestock supplement 1. FIG. 2 is an end elevation view of the packaged livestock supplement 1 illustrated in FIG. 1. As shown in FIGS. 1 and 2, the packaged livestock supplement 1 includes a tray 2, a lid 3, and a livestock supplement 4 that essentially fills the tray 2. The tray 2 has a bottom 5, sidewalls 6, and an open top surrounded by an extended rim 7. The livestock supplement 4 resides within the volume defined by the bottom 5 and sidewalls 6 of the tray 2.

The lid 3 is a polyester backed foil (or similar moisture barrier) and is removably affixed to the extended rim 7, thereby completely enclosing the open top of the tray 2 and forming an airtight seal. Thus, when residing within the volume defined by the bottom 5, sidewalls 6 and sealed lid 3, the livestock supplement 4 is isolated from moisture in the atmosphere until the lid 3 is removed from the extended rim 7 when the supplement 4 is served to a livestock animal. As a result, supplements 4, such as low-moisture, molasses-based products, do not become sticky and messy.

In one embodiment, the tray 2 is made of amorphous polyethylene terephthalate (“APET”). In other embodiments, the tray 2 is made from other polymers (e.g., polyvinyl chloride, copolyester or high impact polystyrene) or from other materials such as aluminum or paper with a barrier coating. In one embodiment, the tray 2 is transparent to allow a purchaser to see the supplement 4 contained therein. In another embodiment, the tray 2 is not transparent. In one embodiment, the tray 2 blocks UV radiation from contacting the supplement 4 contained therein.

In one embodiment, the sidewalls 6 and bottom 5 are thick enough for the trays 2 to serve as rigid molds for the supplement 4 during processing and to allow the trays 2 to be stacked when transported, stored or displayed for sale, yet sufficiently thin to be relatively pliable. The pliability allows the sidewalls 6 and bottom 5 to be displaced inwardly to help discharge the supplement 4 from the interior volume of the tray 2. In one embodiment, the sidewalls 6 and bottom 5 have a thickness ranging from approximately 0.030 inches to approximately 0.040 inches. In another embodiment, the sidewalls 6 and bottom 5 have a thickness ranging from approximately 0.010 inches to approximately 0.040 inches. Finally, in another embodiment, the sidewalls 6 and bottom 5 have a thickness ranging from approximately 0.030 inches to approximately 0.060 inches.

In one embodiment, as illustrated in FIGS. 1 and 2, the sidewalls are sloped such that the resulting supplement 4 has a top that is wider than its base. In one embodiment, the sidewalls 6 and the bottom 5 form an angle a of approximately 90° to approximately 135°. In one embodiment, the sidewalls 6 and the bottom 5 form an angle a of approximately 90° to approximately 125°. In one embodiment, the sidewalls 6 and the bottom 5 form an angle \acute{α} of approximately 90° to approximately 115°. In one embodiment, the sidewalls 6 and the bottom 5 form an angle \acute{α} of approximately 90° to approximately 105°. In one embodiment, the sidewalls 6 and the bottom 5 form an angle \acute{α} of approximately 95° to approximately 105°.

In one embodiment, as shown in FIG. 1A, which is a sectional view taken through a sidewall 6 as indicated in FIG. 1, the sidewalls 6 are ridged or corrugated vertically to provide the sidewalls with additional strength to resist crushing forces when the packaged livestock supplements 1 are stacked during storage, shipping or display. In one embodiment, all sidewalls 6 are ridged or corrugated in this manner. In one embodiment, some, but not all sidewalls 6 are ridged or corrugated. In one embodiment, no sidewalls 6 are ridged or corrugated.

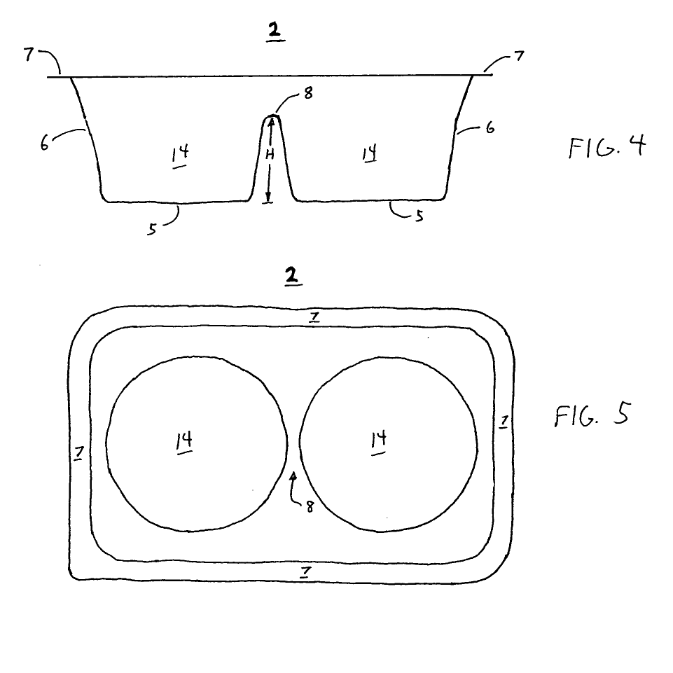

In one embodiment, the corners of the tray 2, formed by the intersections between the sidewalls 6 and the bottom 5 (see FIGS. 1 and 2) and between one sidewall 6 and another sidewall 6 (see FIG. 3), are rounded to facilitate the removal of the supplement 4 from the tray 2. In one embodiment, the corners have a radius range of approximately 0.50 inches to 0.75 inches. In another embodiment, the corners have a radius range of approximately 0.25 inches to 0.60 inches. Finally, in another embodiment, the corners have a radius range of approximately 1 inches to 2 inches.

In an embodiment of the invention configured for smaller mouthed animals (e.g., pre-adult horses and cattle, goats, sheep, swine, and lamas), the interior volume of the tray 2 has the following range of dimensions: a first dimension of approximately 0.50 inches to approximately 1.75 inches; a second dimension of approximately 1.50 inches to approximately 3.00 inches; and a third dimension of approximately 4.00 inches to approximately 6.00 inches. Since the interior volume of the tray 2 serves as a mold for the supplement 4 during processing, a tray 2 having a interior volume with the listed dimensions would provide a similarly configured supplement 4. Thus, smaller mouthed animals would be able to hold in their mouths a substantial portion of the supplement 4 without being able to swallow the supplement 4 outright.

In an embodiment of the invention configured for larger mouthed animals (e.g., adult horses and cattle), the interior volume of the tray 2 has the following range of dimensions: a first dimension of approximately 1.00 inches to approximately 2.00 inches; a second dimension of approximately 2.00 inches to approximately 4.00 inches; and a third dimension of approximately 4.00 inches to approximately 6.00 inches. As a result, larger mouthed animals would be able to hold in their mouths a substantial portion of the supplement 4 without being able to swallow the supplement 4 outright.

In one embodiment, the bottom 5 of the tray 2 is essentially flat. In another embodiment, as indicated in FIGS. 1 and 2, the tray 2 has one or more ridges 8 that protrude into the interior volume of the tray 2. In one embodiment, the bottom 5 of the tray 2 deviates from its horizontal orientation up into the interior of the tray 2 and back down to its horizontal orientation to form the one or more ridges 8. Each ridge 8 creates a groove in the supplement 4 that facilitates the supplement 4 being broken or cut relatively accurately along the groove into equal, measured pieces. In this way a supplement 4, comprising a full measured dose, can be separated by the user into two or more relatively equal doses, particularly when it is desired to offer two or more separate training incentives while still delivering a single full dose.

In one embodiment, the ridge 8 has a height H of approximately 5% to approximately 95% of the height of the interior volume of the tray 2 (i.e., the distance between the top surface of the bottom 5 and the bottom surface of the lid 3). In another embodiment, the ridge 8 has a height H of approximately 15% to approximately 85% of the height of the interior volume of the tray 2. In another embodiment, the ridge 8 has a height H of approximately 25% to approximately 75% of the height of the interior volume of the tray 2. In another embodiment, the ridge 8 has a height H of approximately 35% to approximately 70% of the height of the interior volume of the tray 2. In another embodiment, the ridge 8 has a height H of approximately 45% to approximately 65% of the height of the interior volume of the tray 2. In another embodiment, the ridge 8 has a height H of approximately 55% to approximately 65% of the height of the interior volume of the tray 2. In another embodiment, the ridge 8 has a height H of approximately 10% to approximately 40% of the height of the interior volume of the tray 2. In another embodiment, the ridge 8 has a height H of approximately 10% to approximately 30% of the height of the interior volume of the tray 2.

As indicated in FIGS. 1 and 2, in one embodiment, the packaged livestock supplement 1 will have a void 9 between the top surface of the supplement 4 and the bottom surface of the lid 3. In one embodiment, the supplement 4 is sealed within the interior volume formed by the tray 2 and lid 3, and the void 9 is filled with dry air. In one embodiment, the supplement 4 is sealed within the interior volume formed by the tray 2 and lid 3, and the void 9 is filled with a dry, inert gas (e.g., carbon dioxide, helium, nitrogen). In one embodiment, the supplement 4 is vacuum-sealed within the interior volume formed by the tray 2 and lid 3. In one embodiment, the void 9 is minimal or nonexistent in that the supplement fills the entire interior volume formed by the tray 2 and lid 3, the top of the supplement 4 abutting against the bottom of the lid 3.

FIG. 3 is a top view of the packaged livestock supplement 1 illustrated in FIGS. 1 and 2. As indicated in FIG. 3, the lid 3 is removably affixed to the entire perimeter length of the extended rim 7 to seal closed the open top of the tray 2. In one embodiment, the lid 3 is removably affixed via a glue or adhesive bead 12. In one embodiment, the lid 3 is removably affixed by heat sealing a foil lid 3 to the extended rim 7. The composition of the foil lid 3 and the extended rim 7 must be of materials that are suitable to be heat sealed to one another.

As shown in FIG. 3, a portion of one corner of the lid 3 is not affixed to the extended rim 7. This corner portion serves as an opening tab 11 that can be grasped between a thumb and finger to peal the lid 3 up and away from the extended rim 7, thereby opening the packaged livestock supplement 1.

As illustrated in FIGS. 1, 2 and 3, the sidewalls 6 and the ridge 8 combine to form two or more rectangular pockets 14 in the bottom of the tray 2. Thus, a supplement 4 residing within the tray 2 will have two rectangular formations forming its base.

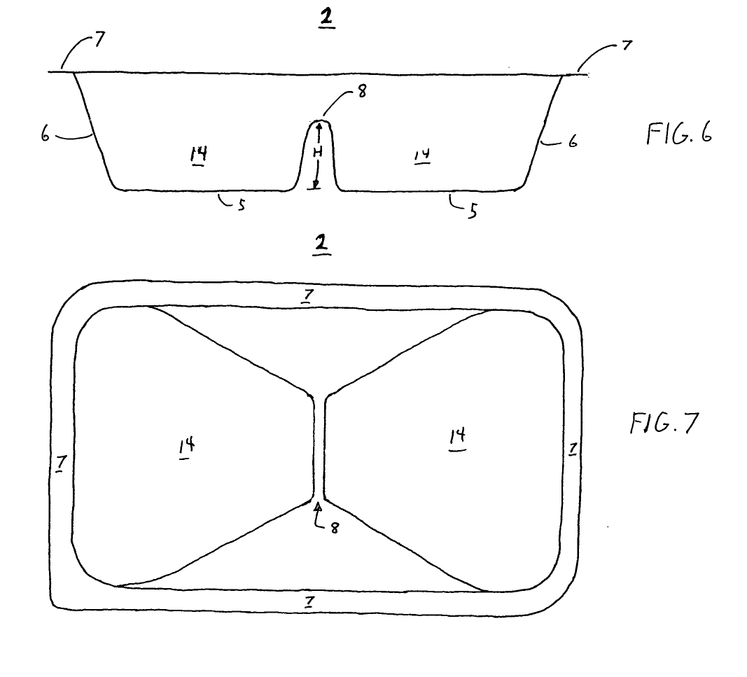

As illustrated in FIGS. 4 and 5, which are side elevation and top views, respectively, of an alternative embodiment of the tray 2, the sidewalls 6 and ridge 8 combine to form two or more circular pockets 14 in the bottom of the tray 2. Thus, a supplement 4 residing within the tray 2 will have two circular formations forming its base. Similarly, as indicated in FIGS. 6 and 7, which are side elevation and top views, respectively, of an alternative embodiment of the tray 2, the sidewalls 6 and the ridge 8 combine to form two or more rounded-cornered, trapezium pockets 14 in the bottom of the tray 2. Therefore, a supplement 4 residing within the tray 2 will have two rounded-cornered, trapezium formations forming its base.

The supplement 4 sealed within the tray 2 is an ingestible (i.e., a product that is intended to be ingested by a livestock animal) that, in one embodiment, is a solid, low-moisture, food product that is formulated to provide 100% of the recommended daily allowances (“RDA”) of various vitamins and minerals. The supplement 4 comprises a sugar-based, sweetening ingredient, a quantity of oil and/or fat, and other desired nutrients such as proteins, vitamins, minerals, and additives.

In more detail, the supplement 4, after conforming to the shape of the tray 2 and cooling, forms a solid bar. In one embodiment, the supplement 4 includes from about 47-82% by weight, preferably from about 60-78% by weight, and more preferably from about 65-73% by weight of a sugar-based sweetening ingredient, based upon the total weight of the supplement 4 taken as 100% by weight. Preferred sweetening ingredients include those selected from the group consisting of molasses, corn syrup, and mixtures thereof. The sweetening ingredients can also be provided with flavorings (such as apple or licorice flavored supplements 4 for horses) as may be desired, for the particular application and suitable to cover the off-odors and flavors of other ingredients.

The supplement 4 generally includes a total oil and/or fat content of from about 2.0-25.0% by weight, and preferably from about 3.0-5.0% by weight, based upon the total weight of the supplement 4 taken as 100% by weight. At least a portion of this oil and/or fat is preferably an edible, hydrogenated vegetable oil or a product derived from such a vegetable oil. The hydrogenated vegetable oil should be present at a level of from about 0.5-1.0% by weight, and preferably from about 0.7-0.8% by weight, based upon the total weight of the supplement 4 taken as 100% by weight. The hydrogenated vegetable oil acts as a moisture barrier and lubricant for the bars.

With respect to the oil and/or fat contained in the supplement 4 that is not a hydrogenated vegetable oil and is not derived from a hydrogenated vegetable oil, it is preferred that this oil and/or fat be a liquid at room temperature. Some preferred such oils and/or fats are soybean oil, rice bran oil, and corn oil.

The vitamins and minerals (“minerals” as used herein includes macro- and micro-nutrients) are preferably present in the supplement 4 at a level of from about 4.0-20.0% by weight, preferably from about 8.5-11.5% by weight, and more preferably from about 10.0-11.0% by weight, based upon the total weight of the supplement 4 taken as 100% by weight. Any vitamins or minerals can be added to the supplement 4 as desired, including but not limited to magnesium, selenium, calcium, copper, zinc, manganese, cobalt, iodine, and both fat soluble and water soluble vitamins. Those skilled in the art will appreciate that, in addition to vitamins and minerals, the supplement can also be used to supply amino acids or large quantities of protein, as well as medicaments such as antibiotics, worming compounds, growth promoters, direct fed microbials, enzymes, other natural medicaments and mixtures of all of the above. In one embodiment, the supplement 4 will include nutraceuticals, such as Omega 3 Fatty Acids in an amount of approximately 1.0% to approximately 2.0% by weight. In one embodiment, the supplement 4 will include phytoceuticals, such as gamma-oryzanol in an amount of approximately 800 mg/lb to approximately 1600 mg/lb by weight.

The supplement 4 is unique in that it can be formulated into very nutrient dense bars weighing, in one embodiment, from about 4 to 16 ounces each, and preferably about 8 ounces each. In another embodiment, the bar will weigh approximately 2 to 8 ounces each. In another embodiment, the bar will weigh approximately 2 to 16 ounces each. In another embodiment, the bar will weigh approximately 8 to 32 ounces each.

In one embodiment, the supplement 4, once it has conformed to the interior volume of the tray 2 and cooled, forms a bar of approximately 5.6 inches×3.5 inches×1.2 inches. In another embodiment, the bar will be approximately 1 to 2 inches tall by 2 to 4 inches wide by 4 to 6 inches long. In another embodiment, the bar will be approximately 1 to 2 inches tall by 4 to 8 inches wide by 4 to 8 inches long. In another embodiment, the bar will be approximately 2 to 4 inches tall by 2 to 4 inches wide by 2 to 4 inches long. Each packaged bar is formulated to provide one dosage of the desired supplemental ingredient(s).

Since a tray 2 for any of the preceding, exemplary bars would only be negligibly larger than its enclosed bar (i.e., supplement 4), it can be understood that a packaged livestock supplement 1 would be of a size and weight that would allow it to be easily transported. For example, most of the packaged livestock supplements 1 for the preceding, exemplary bars would easily fit within a saddle bag, thereby enabling a rider to provide a nutritious and/or medicated treat to the horse out on the trail. Some of these packaged livestock supplements 1 would also fit within a shirt or coat pocket, thereby allowing a trainer to provide a nutritious and/or medicated treat in compact, measured form to a horse in a pen, arena, etc.

As can be understood from the preceding exemplary bars, the dimensions of the supplement 4 are selected such that a livestock animal is able to hold a substantial portion of the supplement 4 in its mouth without being able to swallow it outright. This, coupled with the relative hardness of the supplement 4 (as will be discussed later in this specification), encourages the livestock animal to work on the supplement with its tongue with little or no chewing. The prolonged working facilitates saliva production, which aids in digestion.

In order to ensure a long shelf life, the supplement 4 should have a total moisture content of less than about 8% by weight, and preferably from about 2-4% by weight, based upon the total weight of the supplement 4 taken as 100% by weight. The water activity of the supplement 4 is less than about 0.47, and preferably less than about 0.43. The density (as used herein, “density” is intended to mean actual density rather than bulk density) of the supplement 4 is from about 65-80 lbs/ft³, and preferably from about 70-75 lbs/ft³.

It will be appreciated that the supplement 4 can be used to provide at least about 95%, and preferably at least about 100%, of the RDA of various components to livestock animals. Furthermore, the supplement 4 can be specially formulated as necessary to provide components for which the livestock animal has a particular need. For example, the supplement 4 can be manufactured to provide an increased amount of biotin for livestock animals with a biotin deficiency.

In one embodiment, the single bar (i.e., supplement 4) contained in a single packaged livestock supplement 1 will offer a single controlled dose of vitamins or medicaments that is formulated specifically for the type of livestock animal receiving the supplement 4. For example, a first packaged livestock supplement 1 will have a single controlled dose of nutrients that is formulated specifically for a performance horse, such as a six year old saddle horse that is subjected to strenuous activities several times per week (e.g., moving cattle on a ranch or competing as a roping, cutting or race horse). A second packaged livestock supplement 1 will have a single controlled dose of nutrients that is formulated specifically for a senior horse, such as a 16 year old horse. A third packaged livestock supplement 1 will have a single controlled dose of nutrients for a horse with hooves in poor condition.

Although the aforementioned packaged livestock supplements 1 are intended for horses, the formulations for the first, second and third supplements are calibrated to differ because the horses' nutritional needs differ due to activity level, age or hoof condition. In other embodiments of the packaged livestock supplement 1, the formulation of the supplement 4 will be calibrated to differ based on such factors as the livestock animal's species, breed, gender, age, weight, physical condition, health condition, activity level, dietary intake, etc.

In one embodiment, the amount of nutritional ingredient (e.g., vitamins, minerals, etc.) and/or medicament ingredient (e.g., medicines, phytoceuticals, nutraceuticals, etc.) contained in a single packaged livestock supplement 1 will be based on veterinarian, best-practice, single-dosage, recommendations, as found in The Merck Veterinary Manual, Merck & Co., 6^{th} Edition, 1986. For example, a packaged livestock supplement 1 will have a single controlled dose of medicaments that is formulated specifically to treat a 200-pound calf suffering from scours. This packaged livestock supplement 1, in one embodiment, will provide a 1,000 mg dosage of oxytetracycline HCL for treating the scours in a 200-pound calf. Similarly, where the animal being treated for scours is a 400-pound calf, the packaged livestock supplement 1, in one embodiment, will provide a 2,000 mg dosage of oxytetracycline HCL. In these examples, the livestock supplement is chosen based on the weight of the calf. The livestock supplement is fed twice daily for up to four consecutive days.

Thus, as can be understood from these examples, in one embodiment of the packaged livestock supplement 1, the supplement 4 is formulated to provide a single controlled dose of nutrients or medicaments for a specific type of livestock animal (i.e., a livestock animal of a specific species, breed, gender, age, weight, physical condition, health condition, activity level, dietary intake, or combination thereof; also, a livestock animal suffering from a specific type of illness or nutritional deficiency). Therefore, the packaged livestock supplement 1 requires no measuring prior to being administered and results in no waste because the animal must (and generally will desire to, because of the supplement's palatable nature) consume the entire supplement 4 as a body and thereby receives the prescribed, controlled dose.

Because each packaged livestock supplements 1 is of a specific medicinal and/or nutritional content, the livestock trainer or exhibitor will know the exact amount of various vitamins, nutrients, medicaments, minerals, or other components that a livestock animal is consuming. In fact, the livestock trainer or exhibitor can be certain that the animal is getting all of the particular component that is desired without worrying about overdosing.

Because the supplement 4 includes a sweetening ingredient (and in some embodiments, flavor and odor masking ingredients such as onions, licorice, apples, etc.) the taste of what would otherwise be a distasteful ingredient (e.g., medicament, vitamins, and minerals) is disguised, making the supplement 4 appealing to the livestock animals that consume the supplement 4. Unlike the standard means of delivering medicaments to livestock animals (e.g., injections, boluses, back-lining, etc.), which often results in the animal being restrained and subjected to discomfort, the appealing taste of the supplement 4 builds rapport between the trainer and the animal receiving the medicaments.

The supplement 4 is made by forming a mixture comprising the sugar-based, sweetening ingredient (e.g., molasses, corn syrup, or mixtures thereof) and oil and/or fat, followed by cooking the resulting liquid mixture. The dry ingredients (vitamins, minerals, nutrients, antibiotics, medicaments, including natural medicaments, worming compounds, etc. and a fiber and protein source such as soybean meal) are then mixed with the cooked, liquid mixture at a level of from about 10-47% by weight dry ingredients, preferably from about 25-38% by weight dry ingredients, and more preferably from about 30-35% by weight dry ingredients, based upon the total weight of all ingredients used taken as 100% by weight. As discussed above, the dry ingredients can be formulated as necessary for the particular application for which the supplement 4 is being used.

The resulting mixture is then poured or extruded into trays 2 and allowed to cool via ambient conditions. The mixture in the trays 2 continues to cool via ambient conditions until the temperature of the supplement 4 reaches from about 40-95° F.

The packaged livestock supplement 1 has a shelf life of about 12 months, and preferably at least about 24 months. This is particularly the case when stored in a cool, dry environment.

In cooking the ingredients to form the supplement 4, the desired quantity of molasses (i.e., sweetening ingredient) and oil and/or fats is provided in a mixing cooker and mixing is commenced. While most conventional mixing cookers are suitable for use in preparing the supplement 4, it is preferred that the mixing cooker be heated via steam jackets.

Mixing is continued while the molasses and oil and/or fat mixture is heated to a mixture temperature of from about 220-320° F., preferably from about 240-280° F., more preferably from about 250-265° F., and most preferably from about 255-260° F. Preferably, the mixture is heated to these temperatures in a time period of from about 25-65 minutes, and more preferably from about 40-47 minutes. These preceding temperatures and times correspond to a batch weight of approximately 1000-2000 lbs. These temperatures and times will vary depending on the weight of the batch.

After heating and mixing is complete, the cooked material is pulled from the mixing cooker under a negative pressure of about 10-15 psi, and preferably about 12-14.5 psi, into a negative pressure tank where the cooked material is held for a time period of from about 6-10 minutes, and preferably for about 8 minutes, while being subjected to the negative pressure. The use of such a negative pressure assists in cooling the cooked material as well as in removing moisture from the material.

The material then exits the negative pressure tank and free falls into a holding tank. In a first embodiment, the material is then transported via an auger to a forward portion of the inlet of an extruder. In a second embodiment, the material is transported to a rearward portion of the inlet of the extruder As the cooked material is transported via the auger, the material should have a temperature of from about 125-190° F., and preferably from about 130-140° F.

In the first embodiment, dry materials (i.e., soybean meal, vitamin/mineral mixes, medicaments, etc.) are transported via another auger to the rearward portion of the inlet of the extruder, so that the dry ingredients are fed into the extruder directly behind the cooked material. In the second embodiment, dry materials are transported to the forward portion of the inlet of the extruder, so that the dry ingredients are fed into the extruder directly ahead of the cooked material. The screws of the extruder are rotated at a speed of from about 9-12 rpm, thus forming the supplement 4, which comprises the dry materials and the cooked material and is transported through the barrel of the extruder to its exit.

The supplement 4 exits the extruder as a highly viscous, flowable liquid into a metering device that meters the supplement into open trays 2. The supplement 4 filled trays 2 are then cooled via ambient conditions prior to being provided with a lid 3 and being sealed.

The tray 2 serves as the mold for shaping the measured amount of highly viscous, flowable, liquid supplement into a solid, integral bar (i.e., supplement 4) upon cooling. Specifically, the highly viscous, flowable, liquid supplement assumes, and eventually retains, the shape of the tray 2 as it is cooled. This process results in a packaged livestock supplement 1 that has a container (i.e., a tray 2 with a sealed lid 3) that has moisture barrier qualities and contains a bar (i.e., a supplement 4) that includes a single predetermined, measured dose of one or more nutrients and/or medicaments.

### EXAMPLES

The following example sets forth preferred methods in accordance with the invention. It is to be understood, however, that this example is provided by way of illustration and nothing therein should be taken as a limitation upon the overall scope of the invention.

### Example 1

In this example, a horse nutrition bar is prepared using the following ingredients: high brix cane molasses—484 lbs; soybean oil—20 lbs; soybean meal—100 lbs; and vitamin/mineral premix—70 lbs, which is a key measured/dosed ingredient.

In the preparation of the supplement 4, the molasses and soybean oil are mixed together in a premix tank to achieve a substantially homogenous blend. This mixture is then pumped to a mixing cooker where it is cooked by subjecting the mixture to a continually increasing temperature, until the temperature of the material reaches 260° F. (about 45 minutes). When the material reaches 260° F. the cooked mixture is transferred to a tank at a negative pressure of about 12-13.5 psi, where the mixture is held for about 8 minutes. The cooked mixture then free falls into a holding tank and is then transferred to a double screw extruder. The dry ingredients are added to the double screw extruder just behind the cooked mixture and the screws are rotated for blending together the dry ingredients and the cooked mixture, thereby forming the supplement 4.

The double screw extruder moves the supplement 4, which is a highly viscous, flowable liquid comprising a mixture of cooked molasses, vegetable oil, and the dried ingredients, to a metering device that meters the supplement into trays 2. The supplement filled trays 2 are then transferred away from the metering device via a conveyer. The filled trays 2 are then cooled by ambient conditions to a temperature of about 40-95° F. The lids 3 are then sealed onto the supplement containing trays 2, thereby forming a packaged livestock supplement 1.

In one embodiment, the supplement 4 is formulated in a “maintenance” version for feeding to horses with typical nutritional needs to maintain their health and condition. The “maintenance” version has the following nutrient profile:

| Crude Protein | 10% | |
|---|---|---|
| Lysine | 0.7% | |
| Calcium | 3.0% | |
| Phosphorous | 2.0% | |
| Magnesium | 1.0% | |
| Potassium | 2.0% | |
| Sodium | 0.05% | |
| Sulfur | 0.2% | |
| Iron | 500 | mg/lb |
| Zinc | 500 | mg/lb |
| Copper | 125 | mg/lb |
| Manganese | 500 | mg/lb |
| Iodine | 1.6 | mg/lb |
| Cobalt | 2.1 | mg/lb |
| Selenium | 1.8 | mg/lb |
| Vitamin A | 55 | KIU/lb |
| Vitamin D | 5.5 | KIU/lb |
| Vitamin E | 450 | IU/lb |
| Vitamin B12 | 190 | mcg/lb |
| Riboflavin | 60 | mg/lb |
| d-Pantothenic Acid | 125 | mg/lb |
| Choline | 3850 | mg/lb |
| Niacin | 330 | mg/lb |
| Thiamine | 50 | mg/lb |
| Pyridoxine | 40 | mg/lb |
| Biotin | 2 | mg/lb |
| Folic Acid | 18 | mg/lb |

In one embodiment, the supplement 4 is formulated in a “performance” version for feeding to horses to improve their performance. The “performance” version has the following nutrient profile:

| Crude Protein | 10% | |
|---|---|---|
| Lysine | 0.7% | |
| Calcium | 3.0% | |
| Phosphorous | 2.0% | |
| Magnesium | 1.0% | |
| Potassium | 2.0% | |
| Sodium | 0.05% | |
| Sulfur | 0.2% | |
| Iron | 500 | mg/lb |
| Zinc | 1600 | mg/lb |
| Copper | 500 | mg/lb |
| Manganese | 1600 | mg/lb |
| Iodine | 6.0 | mg/lb |
| Cobalt | 4.0 | mg/lb |
| Selenium | 1.8 | mg/lb |
| Vitamin A | 80 | KIU/lb |
| Vitamin D | 16 | KIU/lb |
| Vitamin E | 2 | KIU/lb |
| Vitamin B12 | 190 | mcg/lb |
| Riboflavin | 60 | mg/lb |
| d-Pantothenic Acid | 125 | mg/lb |
| Choline | 3850 | mg/lb |
| Niacin | 330 | mg/lb |
| Thiamine | 50 | mg/lb |
| Pyridoxine | 40 | mg/lb |
| Biotin | 20 | mg/lb |
| Folic Acid | 18 | mg/lb |
| Ascorbic Acid | 5 | g/lb |

| | |
|---|---|
| Brewer's Dried Yeast | 2.5% |

In one embodiment, the supplement 4 is formulated in a “hoof health” version for feeding to horses to improve their hoof health. The “hoof health” version has the following nutrient profile:

| Crude Protein | 10% | |
|---|---|---|
| Lysine | 0.7% | |
| Calcium | 3.0% | |
| Phosphorous | 2.0% | |
| Magnesium | 1.0% | |
| Potassium | 2.0% | |
| Sodium | 0.05% | |
| Sulfur | 0.2% | |
| Iron | 500 | mg/lb |
| Zinc* | 1600 | mg/lb |
| Copper | 500 | mg/lb |
| Manganese* | 1600 | mg/lb |
| Iodine | 6.0 | mg/lb |
| Cobalt | 4.0 | mg/lb |
| Selenium* | 1.8 | mg/lb |
| Vitamin A | 80 | KIU/lb |
| Vitamin D | 16 | KIU/lb |
| Vitamin E | 2 | KIU/lb |
| Vitamin B12 | 190 | mcg/lb |
| Riboflavin | 60 | mg/lb |
| d-Pantothenic Acid | 125 | mg/lb |
| Choline | 3850 | mg/lb |
| Niacin | 330 | mg/lb |
| Thiamine | 50 | mg/lb |
| Pyridoxine | 40 | mg/lb |
| Biotin* | 40 | mg/lb |
| Folic Acid | 18 | mg/lb |

(*denotes key measured/dosed nutrients)

In one embodiment, the supplement 4 is formulated in a “senior” version for feeding to senior horses to meet their special nutritional requirements. The “senior” version has the following nutrient profile:

| Crude Protein | 10% | |
|---|---|---|
| Lysine | 0.7% | |
| Calcium | 3.0% | |
| Phosphorous | 2.0% | |
| Magnesium | 1.0% | |
| Potassium | 2.0% | |
| Sodium | 0.05% | |
| Sulfur | 0.2% | |
| Iron | 500 | mg/lb |
| Zinc | 1600 | mg/lb |
| Copper | 500 | mg/lb |
| Manganese | 1600 | mg/lb |
| Iodine | 6.0 | mg/lb |
| Cobalt | 4.0 | mg/lb |
| Selenium | 1.8 | mg/lb |
| Vitamin A* | 80 | KIU/lb |
| Vitamin D* | 16 | KIU/lb |
| Vitamin E* | 2 | KIU/lb |
| Vitamin B12* | 190 | mcg/lb |
| Riboflavin* | 60 | mg/lb |
| d-Pantothenic Acid* | 125 | mg/lb |
| Choline* | 3850 | mg/lb |
| Niacin* | 330 | mg/lb |
| Thiamine* | 50 | mg/lb |
| Pyridoxine* | 40 | mg/lb |
| Biotin* | 20 | mg/lb |
| Folic Acid* | 18 | mg/lb |
| Ascorbic Acid* | 10 | g/lb |

| | |
|---|---|
| Brewers Dried Yeast* | 2.5% |

(*denotes key measured/dosed nutrients)

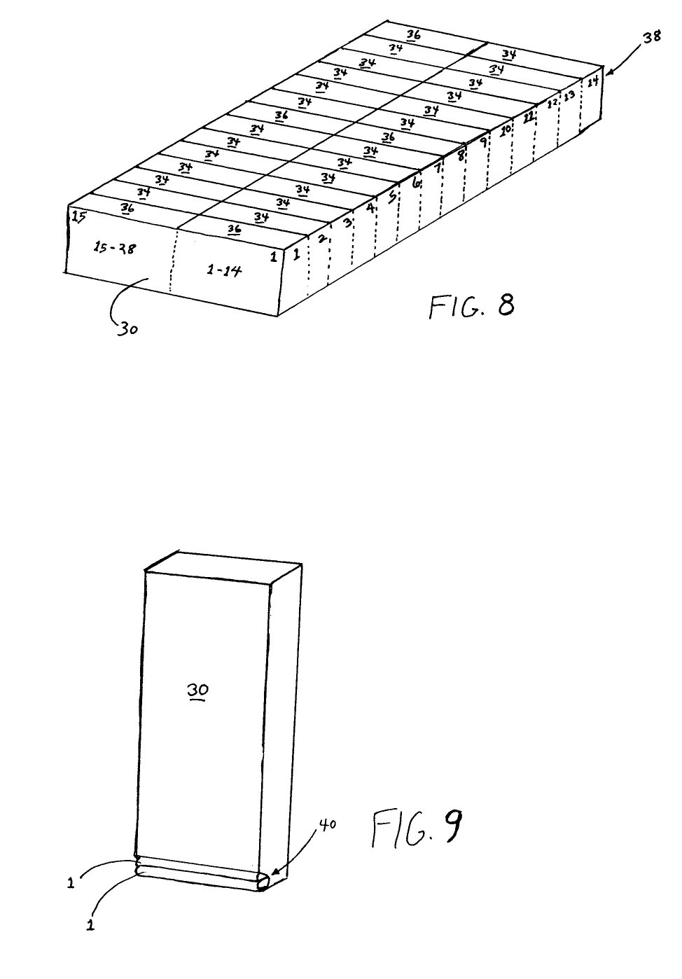

In one embodiment, the invention entails a regimented system for administering packaged livestock supplements 1 to a livestock animal over a predetermined administration period. As illustrated in FIGS. 8 and 9, the system utilizes a set of packaged livestock supplements 1 held in a container 30 that, in one embodiment, is specially adapted for the purpose.

In one embodiment, each container 30 will hold a group of packaged livestock supplements 1. Each group will comprise a plurality of packaged base supplements (“PBS”) 34 and at least one packaged special supplement (“PSS”) 36. In one embodiment, the PBS 34 and the PSS 36 are arranged in the container 30 in the order in which they are to be administered to the livestock animal. In one embodiment, an indicator 38 is provided with the container 30 to indicate the order in which the PBS 34 and PSS 36 are to be administered to the livestock animal.

A PBS 34 is a packaged livestock supplement 1 that contains general, everyday nutrients that a healthy livestock animal should receive to maintain its overall health. In other words, the packaged base supplement 34 does not contain special medications or nutrients that would be needed by a livestock animal that was ill, injured, or suffering from an atypical nutritional deficiency. It is termed a packaged base supplement 34 because it serves as the default packaged livestock supplement 1 administered to the livestock animal during the predetermined administration period. The PBS 34 is provided during each administration of a packaged livestock supplement 1, unless it is specifically time for a PSS 36 to be administered.

Where the livestock animal has typical nutritional needs, the applicable PBS 34 could be any maintenance type supplement specifically formulated to provide the nutrients needed by a typical livestock animal. In one specific embodiment for a horse with typical nutritional needs, the applicable PBS 34 would have a formulation as recited above for the “maintenance” version of the supplement 4. In other maintenance embodiments for horses and other livestock animals, the PBS 34 would have other formulations.

Where the livestock animal is a performance type animal (e.g., a roping horse, race horse, cutting horse, etc.), the applicable PBS 34 could be any performance type supplement specifically formulated to replace the nutrients (e.g., minerals, vitamins, protein, etc.) lost by athletic animals during the course of their training and competitions. In one specific embodiment for a performance horse, the applicable PBS 34 would have a formulation as recited above for the “performance” version of the supplement 4. In other performance embodiments for horses and other livestock animals, the PBS 34 would have other formulations.

Where the livestock animal is a senior type animal (i.e., a mature animal of advanced age or an elderly animal), the applicable PBS 34 could be any senior type supplement specifically formulated to provide the nutrients and/or medicaments needed by a senior livestock animal. In one specific embodiment for a senior horse, the applicable PBS 34 would have a formulation as recited above for the “senior” version of the supplement 4. In other senior embodiments for horses and other livestock animals, the PBS 34 would have other formulations.

The preceding embodiments for the PBS 34 are provided as examples. Those skilled in the art will readily recognize that other livestock species, ages, etc. may be provided with maintenance formulations specifically designed for them. For example, maintenance formulations may be developed for lactating livestock animals, pre-adult livestock animals, and livestock animals with continuous medical conditions such as heart or weight problems. These maintenance formulations would have the nutrients and/or medicament needed at every administration of the packaged livestock supplement 1 within the predetermined administration period. Therefore, those other formulations for the PBS 34 should be considered as being part of this specification, and the specification should not be considered as being limited by the preceding examples.

A PSS 36 is a packaged livestock supplement 1 that contains medications and/or special nutrients to meet a livestock animal's special needs that have arisen because of atypical circumstances, such as illness, injury, special or severe nutritional deficiency, severe exertion, etc. In other words, the PSS 36 is formulated to meet a livestock animal's special health needs. It is termed the packaged special supplement 36 because it is not the default packaged livestock supplement 1 administered during the predetermined administration period. The PSS 36 is only provided during special administrations within the predetermined administration period.

Where the livestock animal has a parasite (e.g., worms), the applicable PSS 36 could be a supplement specifically formulated to contain an anti-parasite agent (e.g., a wormer). Where the livestock animal has poor hoof health, the applicable PSS 36 could be a supplement specifically formulated to contain nutrients and/or medicaments for improving hoof health. Where the livestock animal has less than desirable coat health and appearance, the applicable PSS could be a supplement specifically formulated to contain nutrients and/or medicaments for improving coat health and appearance. These embodiments for the PSS 36 are provided as examples. Those skilled in the art will readily recognize that other livestock aliments or atypical conditions may be addressed by other formulations for the PSS 36 for various livestock animals. Thus, those other formulations for the PSS 36 should be considered as being part of this specification, and the specification should not be considered as being limited by the preceding examples.

As shown in FIG. 8, each packaged livestock supplement 1 (i.e., PBS 34 and PSS 36) occupies a position within the container 30. The container 30 has an indicator 38 for indicating the order in which the each packaged livestock supplement 1 is to be administered to the livestock animal during the predetermined administration period. In one embodiment, as shown in FIG. 8, the indicator 38 is a series of sequential numbers along the side of the container 30. Each position is associated with a number that corresponds to the order in which the packaged livestock supplement 1 (i.e., PBS 34 and PSS 36) is to be administered to the livestock animal during the predetermined administration period.

In one embodiment, the packaged livestock supplements 1 are located in the container 30 (preferably arranged in their order of administration) and text, symbols or diagrams on the container or another surface serve as the indicator to indicate the order of administration. In one embodiment, the packaging for the packaged livestock supplement 1 is printed with a number that serves as an indicator to indicate the order of administration.

In one embodiment, as illustrated in FIG. 9, the packaged livestock supplements 1 (i.e., PBS 34 and PSS 36) are arranged in the container in their order of administration. In one embodiment, as shown in FIG. 9, the container 30 has a slot 40 for individually removing the packaged livestock supplements 1 in their appropriate administration order.

In one embodiment, as shown in FIG. 8, the container holds 28 packaged livestock supplements 1 and is meant for a predetermined administration period of four weeks during which a single packaged livestock supplement 1 is administered per day. In other embodiments, depending on the frequency of the administrations and the length of the predetermined administration period, the container 30 will hold any other number of packaged livestock supplements 1. For example, where the packaged livestock supplement 1 is to be administered once per day and the predetermined administration period is one week, the container 30 will hold 7 packaged livestock supplements. As an additional example, where two packaged livestock supplements 1 are to be administered per day and the predetermined administration period is four weeks, the container will hold 56 package livestock supplements 1.

In one embodiment, as indicated in FIG. 8, PSS 36 are located in positions one, eight, 15, 22 and 28, which represent the corresponding administration days in the predetermined four week administration period. Positions one, eight, 15 and 22 are occupied by a PSS 36 specially formulated to promote hoof health. Position 28 is occupied by a PSS 36 specially formulated to contain a wormer. The remaining positions within the container 30 are occupied by a PBS 34, such as a PBS 34 having a performance formulation. As can be understood by those skilled in the art, other combinations of PBS 34 and PSS 36 are possible. Also, other types of PBS 34 and PSS 36 may be employed. Therefore, this specification should not be limited by the preceding example.

To implement the regimented system for administering a packaged livestock supplement 1, the livestock trainer or exhibitor obtains a container 30 that has the PBS 34 and PSS 36 that address the normal and special needs of the livestock animal that will be receiving the packaged livestock supplement 1. The container 30 obtained will have sufficient packaged livestock supplements 1 to meet the livestock animal's needs over the predetermined administration period.

Referring to the container 30 described above and illustrated in FIG. 8, on the first day of the 28 day long administration period, the livestock animal receives the PSS 36 residing within the first position in the container 30 (i.e., the animal receives a PSS 36 formulated to promote hoof health). On each of days two through seven, the animal receives a PBS 34 (i.e., a performance formulated PBS 34). These are taken in order from positions two through seven in the container 30.

On the eighth day, the animal receives from the eighth position in the container 30 another PSS 36 formulated to promote hoof health. On each of days nine through 14, the animal again receives a performance formulated PBS 34.

On the fifteenth day, the animal receives from the fifteenth position in the container 30 another PSS 36 formulated to promote hoof health. On each of days 16 through 21, the animal again receives a performance formulated PBS 34.

On the twenty-second day, the animal receives from the twenty-second position in the container 30 another PSS 36 formulated to promote hoof health. On each of days 23 through 27, the animal again receives a performance formulated PBS 34. On day 28, the animal receives a PSS 36 formulated to contain a worming agent.

This regimented system for administering a packaged livestock supplement 1 is advantageous because it provides a livestock trainer or exhibitor with an easy means of providing livestock feed supplements in the appropriate doses and at the appropriate times within an administration period.

Although the present invention has been described with reference to preferred embodiments, persons skilled in the art will recognize that changes may be made in form and detail without departing from the spirit and scope of the invention.

1. A method of forming a nutritional food product comprising the steps of:
(a) forming a mixture comprising a sugar-based sweetening ingredient and a quantity of oil and/or fat;
(b) cooking said mixture by heating to a temperature of from about 220-320 degrees F. to yield a low-moisture cooked liquid mixture;
(c) mixing said liquid mixture with a measured proportional quantity of dry materials including an ingredient selected from the group consisting of vitamins, minerals, proteins, phytochemicals, nutraceuticals and other nutrients and mixtures thereof, said ingredient to be delivered in a measured dose;
(d) supplying said mixture resulting from step (c) to a metering device;
(e) delivering in a highly viscous state out of the metering device and into a container with moisture barrier qualities a measured amount of the mixture sufficient to provide a predetermined measured dose of said ingredient, said container serving as a mold for shaping the measured amount into a solid, integral mass upon cooling; and
(f) sealing the container with a removable moisture barrier.

2. The method of claim 1, wherein the container is a tray comprising a bottom, sidewalls, and an open top, the bottom and sidewalls defining a volume for receiving the mixture.

3. The method of claim 2, wherein the container bottom comprises a ridge.

4. The method of claim 2, wherein the container further comprises an extended rim along said open top.

5. The method of claim 4, wherein the removable moisture barrier affixes to the extended rim.

6. The method of claim 2, wherein the removable moisture barrier is a polyester backed foil.

7. The method of claim 2, wherein the container is formed from amorphous polyethylene terephthalate, polyvinyl chloride, copolyester or high impact polystyrene.

8. An edible nutritional food in the form of an integral, self-sustaining body within a dosage package, comprising:
a sugar-based sweetening ingredient;
a quantity of oil and/or fat;
a quantity of a supplement mixed with said sweetening ingredient and oil and/or fat, said supplement comprising an ingredient selected from the group consisting of proteins, vitamins, minerals, phytochemicals, nutraceuticals and other nutrients and being supplied in a measured proportion;
said dosage package containing a metered amount of the supplement mixed with said sweetening ingredient and oil and/or fat sufficient to provide a predetermined measured dose of said supplement, said dosage package comprising a container with moisture barrier qualities filled with the metered amount conforming to the shape of the container and being sealed with a removable moisture barrier; and
said metered amount having a total moisture content of less than about 8% by weight, based upon the total weight of the metered amount taken as 100% by weight.

9. The product of claim 8, wherein the container is a tray comprising a bottom, sidewalls, and an open top, the bottom and sidewalls defining a volume for receiving the mixture.

10. The product of claim 8, wherein the container bottom comprises a ridge.

11. The product of claim 8, wherein the container further comprises an extended rim along said open top.

12. The product of claim 11, wherein the removable moisture barrier affixes to the extended rim.

13. The product of claim 8, wherein the removable moisture barrier is a polyester backed foil.

14. The product of claim 8, wherein the container is formed from amorphous polyethylene terephthalate, polyvinyl chloride, copolyester or high impact polystyrene.

15. A method of administering a livestock supplement, the method comprising:
(a) selecting a livestock animal to receive a livestock supplement;
(b) determining at least one characteristic of the livestock animal selected from the group consisting of species, breed, gender, age, weight, physical condition, health condition, type of nutritional deficiency, type of illness, activity level, and dietary intake;
(c) selecting a packaged integral livestock supplement that provides a single controlled dose of ingredients formulated to correspond to the at least one characteristic, wherein the packaged livestock supplement comprises a low-moisture, molasses-based product sealed in a container having a removable lid, the container and lid having moisture barrier qualities;
(d) removing the molasses-based product from the container; and
(e) providing the molasses-based product to the livestock animal.

16. A method of claim 15, wherein the ingredients include medicaments.

17. The method of claim 15, wherein the ingredients include vitamins.

18. The method of claim 15, wherein the ingredients include minerals.

19. The method of claim 15, wherein the container is a tray comprising a bottom, sidewalls, and an open top, the bottom and sidewalls defining a volume for holding the molasses-based product.

20. The method of claim 19, wherein the container bottom comprises a ridge.

21. The method of claim 19, wherein the container further comprises an extended rim along said open top.

22. The method of claim 21, wherein the removable top affixes to the extended rim.

23. The method of claim 19, wherein the removable top is a polyester backed foil.

24. The method of claim 19, wherein the container is formed from amorphous polyethylene terephthalate, polyvinyl chloride, copolyester or high impact polystyrene.

25. A set of packaged supplements for regimented administration to a livestock animal, the set comprising:
a plurality of packaged base supplements;
at least one packaged special supplement; and
a container adapted to hold said plurality of base supplements and said at least one special supplement,
wherein the total number of supplements held within the container corresponds to the number of supplements to be administered during a predetermined administration period.

26. The set of claim 25, further comprising an indicator for indicating the order in which the base and special supplements are to be administered to the livestock animal during the predetermined administration period.

27. The set of claim 25, wherein the base and special supplements are arranged in the container to indicate the order in which the supplements are to be administered to the livestock animal during the predetermined administration period.

28. The set of claim 25, wherein the base supplement is formulated to maintain the livestock animal's overall health and the special supplement is formulated to meet the animal's special health needs.

29. The set of claim 28, wherein the base supplement is a low-moisture, molasses-based supplement formulated for the nutritional needs of a performance livestock animal.

30. The set of claim 28, wherein the base supplement is a low-moisture, molasses-based supplement formulated for the nutritional needs of a senior livestock animal.

31. The set of claim 28, wherein the base supplement is a low-moisture, molasses-based supplement and wherein its formulation is a maintenance formulation, a performance formulation, or a senior formulation.

32. The set of claim 28, wherein the special supplement is a low-moisture, molasses-based supplement containing a wormer.

33. The set of claim 28, wherein the special supplement is a low-moisture, molasses-based supplement containing a hoof health enhancer.

34. The set of claim 28, wherein the special supplement is a low-moisture, molasses-based supplement containing a coat health enhancer.

35. The set of claim 25, wherein the container holds a total of 28 supplements, at least one of which is a special supplement selected from the group consisting of a wormer, a coat health enhancer, and a hoof health enhancer, and the remaining supplements being a base supplement selected from the group consisting of a maintenance formulated supplement, a performance formulated supplement, and a senior formulated supplement.

36. The set of claim 25, wherein the container holds a total of 7 supplements, at least one of which is a special supplement selected from the group consisting of a wormer, a coat health enhancer, and a hoof health enhancer, and the remaining supplements being a base supplement selected from the group consisting of a maintenance formulated supplement, a performance formulated supplement, and a senior formulated supplement.
